(19) United States
(12) Patent Application Publication
(10) Pub. No.: US 2009/0154352 A1
(43) Pub. Date: Jun. 18, 2009

(54) NETWORK SCHEDULING

(75) Inventor: Yong SUN, Bristol (GB)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/236,958

(22) Filed: Sep. 24, 2008

(30) Foreign Application Priority Data
Dec. 18, 2007 (GB) 0724620.0

(51) Int. Cl. H04L 1/00

(52) U.S. Cl. 370/235

(57) ABSTRACT

A method of scheduling transmission between a base station (2) and a plurality of mobile stations (4, 6, 8, 10, 12), comprise determining at least one transmission threshold, transmitting the at least one transmission threshold to the plurality of mobile stations (4, 6, 8, 10, 12), comparing, at each mobile station, the at least one transmission threshold to a service parameter for that mobile station, and scheduling transmission from the base station (2), the scheduling being dependent on the outcome of the comparisons.

The present invention relates to network scheduling, and in particular to scheduling of multi-user access to a network.

The invention has particular application to cellular networks, but is not limited only to the field of cellular networks and may, for instance, be applied to any wireless system, such as WLANs, WPANs, UWB.

The feature of multi-user diversity within multi-user transmission systems has attracted much attention. It has been proposed that multi-user access should be scheduled through a central control mechanism, especially in a cellular application.

A scheduling policy is a set of rules, procedures, or criteria used in making transmission scheduling decisions. Fundamentally, scheduling is essential to coordinate the transmissions to or from independent users in a communication system and network. The scheduling of different links is interdependent in wireless networks, whereas different links can be scheduled independent of each other in wire line networks. The main purpose of scheduling algorithms is to minimize resource starvation and to ensure fairness amongst the users utilizing the resources.

There are many scheduling algorithms from simple ones such as random scheduler algorithms, or first-in first-out (FIFO), to more complex schemes which provide for resource management for wireless systems by taking advantage of multiuser diversity, allowing delay variation in delivering data packets.

A simple approach to user selection in a cellular multi-user transmission system can be seen as a closed-loop problem in which a base station (BS) is required to collect, normally via a feedback mechanism, all information from any mobile stations (MS) that require transmission of data from the base station. Based on all of the feedback information, the base station is able to select mobile station(s) for transmission.

However, the simple approach to user selection in multi-user transmission systems mentioned in the preceding paragraph is still far away from realistic implementation as it requires the feedback of huge amounts of information, which severely reduces the transmission efficiency. Recently, other techniques have been developed to tackle the problem, such as random beam-forming (RB), cooperative diversity including opportunistic relay (OR), and virtual MIMO.

Co-operative diversity techniques rely on co-operation between terminals distributed in space, and can significantly improve the performance of wireless communication. In the simplest case, a pair of neighbouring nodes that know each other's channel state information (CSI) can co-operatively beam-form towards a final destination, increasing total capacity. However, scaling cooperation to more than one relay is still an open area of research, despite the recent interest in cooperative communication. For example, it is impractical for each relay to acquire CSI about other relays or for a destination to acquire CSI between the source and all relays.

Opportunistic relay has been proposed as one approach to minimize the required co-operation overhead and to simultaneously realize the potential benefits of cooperation between multiple relays. For instance, a simple, distributed, single-relay selection algorithm for slow fading wireless environments has been proposed in A. Bletsas et al, “A simple co-operative diversity method based on network path selection”, IEEE J. Select. Areas Commun., 2006. However, even taking into account such developments opportunistic relay is not suitable to support practical cellular environment with high speed mobility. Opportunistic relay techniques also rely on the ideal assumption that there are several idle relaying nodes available for use in a network operation for a single user.

Turning to random beam-forming techniques, such techniques require the forming of a transmission beam transmitted via multiple transmit antennas, and the matching of the powers and phases of the signals sent on the transmit antennas to the channel gains for the various mobile terminals in order to maximize the received SNR at the mobile terminals. Every mobile station is required to feedback a measure of its channel gain or quality to the base station.

In general, random beam-forming is more suitable for non-real time application. Also there are two main assumptions which have to be considered when random beam-forming is deployed in a wireless network. These are that:
at the base station, the magnitudes and phases of the channel gains from the transmit antennas to all of the users have to be tracked and fed back to the base station; and
a considerable number of mobile terminals requiring transmission from the base station need to be present at the same time within the service area under consideration for the technique to be effective.

The major drawbacks arising from the two assumptions above are that, with regard to the first assumption, the process still requires a considerable amount of feedback and pre-processing to determine user access and, with regard to the second assumption, the number of mobile terminals that are active has a direct impact on the performance of the random beam-forming technique. Therefore, acceptable results might not be obtained if the number of mobile users within the service area is sparse, and the results that are obtained may vary as the number of users varies. Based on those two observations, known random beam-forming techniques are not an attractive solution for implementation in wireless systems.

The problems with known scheduling procedures are likely to exacerbated in the future as it is becoming increasingly important to be able to support many different services in a single network, each having different throughput and quality of service requirements.

A network may be required to support applications having a range of throughputs from several Kbps to several Gbps. Conventional scheduling schemes, which may be based upon optimising total throughput or upon providing the same throughput to each mobile terminal may not provide satisfactory results in such networks in which every mobile terminal may require totally different throughputs. For instance, scheduling schemes based upon optimising total throughput may provide little or no data throughput to some mobile terminals having low data-rate and/or high data-rate requirements.

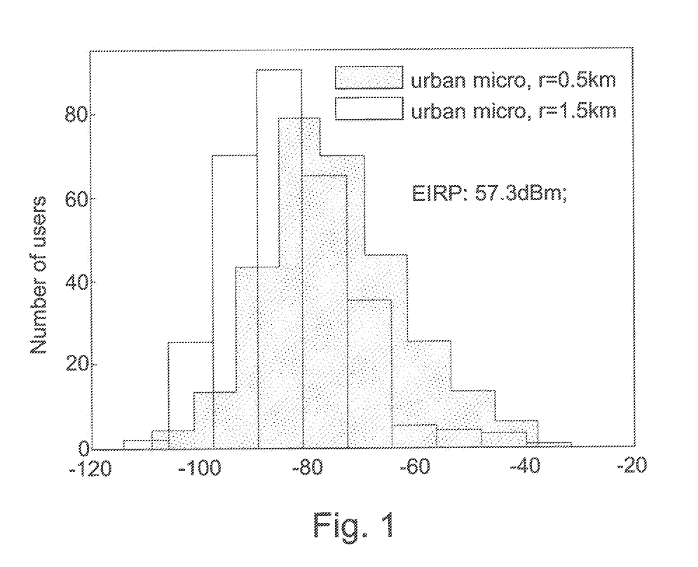

In realistic applications, it is difficult to maintain levels of quality of service. For instance if an attempt was made to provide a guaranteed quality of service, the nature of the cellular environment means that it could not always be guaranteed that each mobile station would obtain that quality of service. A typical distribution of users' received power in a cellular application environment, for both an urban macro-cell and an urban micro-cell is shown FIG. 1. It can be seen that the average received power at mobile terminals in the urban macro-cell is much reduced compared to that of the micro-cell. This occurs as a result of the larger cell radius and the more severe shadowing. However as shown clearly, even with small cell size (only up to 0.5 km for the micro-cell in the example shown) there are still some users receiving very low power.

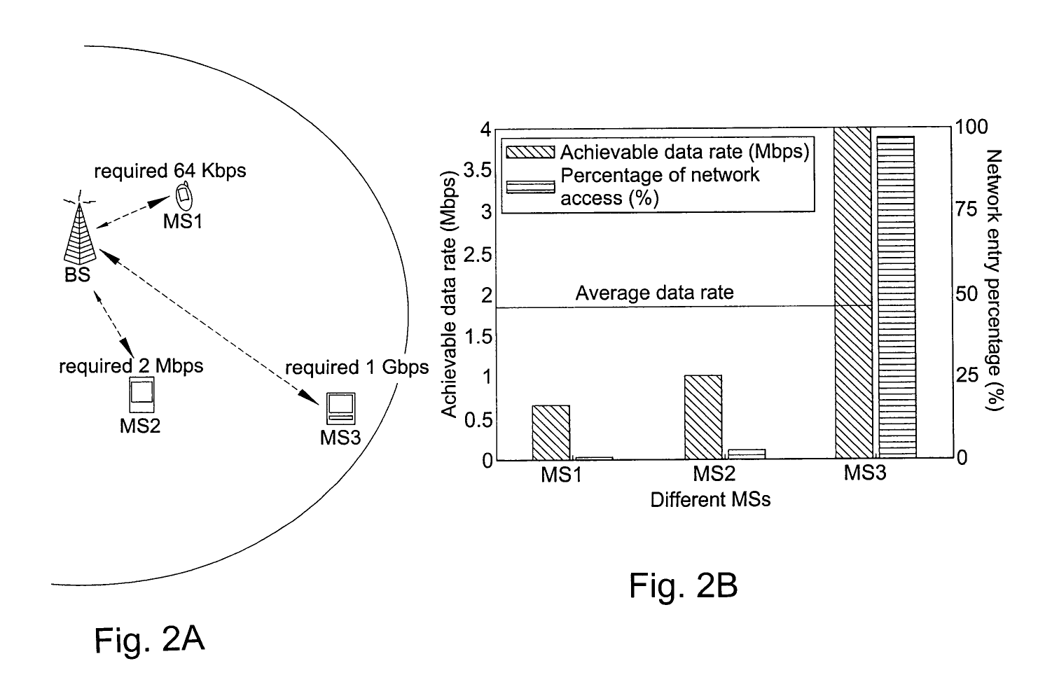

Furthermore, it may be desired to maintain a guaranteed quality of service whilst also providing a desired level of overall network performance, based for instance on total data throughput across all mobile stations. Conventional scheduling schemes are unable to address those issues, without affecting fairness of access across all mobile stations. As an example, FIG. 2a shows the locations of different mobile stations MS1 MS2 MS3 having different service requirements, relative to a base station BS. A mobile station MS3 located at the far end of the coverage area of the base station requests a high data rate service, and the other mobile stations request lower data rate services. As the far mobile station MS3 is almost at the edge of the cell, the network is not able to match both its requested data rate and the average throughput requirements for each of the other mobile stations MS1 MS2. According to conventional proportional scheduling, transmission would be scheduled mostly to that far mobile station MS3, thus treating the other mobile stations MS1 MS2 unfairly. That is illustrated in FIG. 2b, which shows the achievable data rate and percentage of network access for each of the mobile stations using a conventional proportional scheduling.

The present invention aims to provide an improved or at least alternative method of scheduling transmission. In particular embodiments, the invention may provide an advance scheduling scheme for multi-user transmission that targets both fairness and quality of service.

In a first independent aspect of the invention, there is provided a method of scheduling transmission between a base station and a plurality of mobile stations, comprising: determining at least one transmission threshold; transmitting the at least one transmission threshold to the plurality of mobile stations; comparing, at each mobile station, the at least one transmission threshold to a service parameter for that mobile station; and scheduling transmission from the base station, the scheduling being dependent on the outcome of the comparisons.

By making the scheduling dependent on the outcome of comparisons performed at the mobile stations themselves, the processing load for scheduling the transmission can be shared between the mobile stations and the base station, and the processing burden on the base station can be reduced.

Thus, system service and quality may be established, in an initial procedure, by the determination of the at least one transmission threshold to be transmitted. That is particularly useful in the context of the latest, and future, generations of wireless communication that may support a wide range of services, including voice, data, high-speed streaming, real time and/or non-real time applications. The base station may be configured to budget the service level to be provided in order to achieve a targeted network performance.

The service parameter may comprise, for instance, a measure of channel quality, desired quality of service, or desired data transmission rate.

Preferably, each mobile station determines whether or not to send a request for service to the base station in dependence upon the comparison at that mobile station.

Thus, the number of mobile stations sending requests for service to the base station can be reduced, reducing the communication load between the base station and the mobile stations. Unnecessary transmissions from the mobile stations can be avoided.

Furthermore, as the base station receives fewer requests for service from the mobile stations, scheduling operations at the base station can be simplified.

Preferably the method comprises determining the or each transmission threshold in dependence upon one or more of transmission power, transmission coverage, and the outcome of a scheduling procedure.

The or each transmission threshold may comprise a quality of service threshold. Thus, the method may provide a particularly convenient way of ensuring that transmission can be scheduled in dependence on quality of service, and that mobile stations can obtain a quality of service from the base station that is dependent on their desired quality of service. The provision of a respective level of quality of service to each mobile station may be guaranteed.

The term quality of service as used herein is a measure of the rate and quality of data transmission between a base station and a mobile station. The quality of service between a base station and a particular mobile station may, for many applications, be taken as being the average rate of data transmitted by the base station and correctly received by the mobile station. For some applications, the quality of service may also include a component representative of, for instance, reliability of transmission and/or error rate, and/or received or transmitted power, and/or a requirement that any gaps in transmission are below a certain length and/or a requirement for the rate of data transmission to not vary too widely over different time periods.

The measure of quality of service that is used depends on the requirements of the mobile stations. For example, if a mobile station is running a streaming video application, then the mobile station may require that the average rate of data transmitted by the base station and correctly received by the mobile station is above a certain level, but may also require that there are no gaps in transmission longer than a certain period, to ensure that there are no gaps or jumps in the streaming video. The quality of service required by the mobile station in that example would comprise a required average data rate correctly received by the mobile station and a required maximum gap in transmission.

For a network, the quality of service provided to each mobile station by a base station is dependent on the quality of service provided to the other mobile stations, and network scheduling may involve the balancing of the quality of service required or desired by each mobile station.

The service parameter may be a measure of desired quality of service.

In one example, two levels of quality of service may be provided. One level of quality of service may be a guaranteed quality of service that specifies the lowest level of quality of service that it should be able to provide to each mobile terminal in service. The other level of quality of service may be a targeted quality of service or network targeted performance, which gives a target for an operator to achieve, for instance for a particular purpose or application. The performance ranges may be defined in relation to those levels of quality of service, and thresholds may be set equal to those levels of quality of service. In that case one performance range may cover quality of service up to the guaranteed quality of service, another performance range may cover quality of service equal to and greater than the guaranteed quality of service up to the targeted quality of service, and another performance range may cover quality of service equal to and greater than the targeted quality of service.

Preferably the method further comprises determining, for each mobile station, the respective service parameter in dependence upon one or more of channel quality, direction of arrival at the mobile station of a transmission from the base station, position of the mobile station, distance of the mobile station to the base station, and required quality of service.

Thus, the scheduling may take into account varying levels of channel quality between the base stations and mobile stations, and relative movement of the base station and each mobile station. By taking into account the required quality of service of each mobile station the scheduling may also be able to optimise the overall quality of service provided across all mobile stations, whilst also providing a fair distribution of service across the mobile stations.

Preferably, for each mobile station, determination of the service parameter is performed by the mobile station itself.

Thus, the burden on the base station and on communication or network capacity between the base station and the mobile stations may be reduced. Also, by determining the respective service parameter at each mobile station itself, a particularly efficient and rapid way of ensuring that changes in the status of the mobile station or of the channel or link between the mobile station and the base station are taken into account.

Each mobile station may determine the value of its own service parameter.

Each mobile station may be able to vary its desired quality of service and/or the value of the service parameter in dependence upon the quality of the channel between it and the base station.

So, for instance, a mobile station with low received power may be aware of its status and may be able to reconfigure itself or to vary the value of the service parameter accordingly. The mobile station may also be able to reconfigure itself, or change the value of its service parameter, in dependence upon the values of the thresholds. In one example, a mobile station with low receiving power may reconfigure itself to have a desired quality of service equal to an expected quality of service that can be guaranteed, and to alter its service parameter accordingly.

Each mobile station may be configured to vary its status, preferably by variation of the value of its service parameter, in order to obtain, for instance, an expected level or quality of service, or data rate. Each mobile station may be configured to vary its status in dependence upon its rate of power consumption, and battery level.

Preferably the method further comprises determining a plurality of transmission thresholds, the plurality of transmission thresholds defining a set of performance ranges.

The performance ranges may be representative of the speed, capacity or reliability of the transmission link or channel from the base station.

The method may further comprise selecting at the base station at least one of the performance ranges, the at least one transmission threshold transmitted to the plurality of mobile stations being representative of the selected at least one performance range.

Thus, a particularly efficient way of scheduling service from the base station in dependence on level of performance is provided, which is of particular importance when different mobile stations require different levels of service.

The selection of one of the performance ranges of the plurality of performance ranges may be performed using a scheduling algorithm.

The method may further comprise selecting one of the mobile stations falling within the selected performance range using a further scheduling algorithm.

Thus, the method may provide a double scheduling which may ensure that service is provided fairly to every mobile station taking into account the level of service required by each mobile station.

That feature is particularly important and so in a further independent aspect there is provided a method of scheduling transmission from a base station to a plurality of mobile stations, comprising: determining a plurality of performance ranges; applying a scheduling algorithm to select one of the performance ranges; applying a further scheduling algorithm to select a mobile station included in the selected performance range; and scheduling transmission from the base station to the selected mobile station.

Preferably each of the performance ranges comprises a respective range of quality of service.

Each of the scheduling algorithm and/or the further scheduling algorithm preferably comprises one of a random scheduling algorithm, a first-in first-out (FIFO) algorithm, and a proportional scheduling algorithm.

The method may further comprise:
a) determining a target performance level,
b) determining an achieved performance level,
c) comparing the target performance level and the achieved performance level,
d) scheduling transmission in dependence upon the comparison,
e) updating the achieved performance level following the scheduled transmission, and
f) repeating b) to e)

Thus, an iterative scheduling procedure may be provided, which may ensure that a target performance level is achieved. The performance levels may be network performance levels, and may measure for instance rate of data transmission across a network linking the base station and the mobile stations. The achieved performance level may be an average of performance level achieved over a pre-determined period of time.

The method may further comprise assigning each performance range to either a high performance group or a low performance group, and selecting one of the high performance group or the low performance group in dependence on whether the achieved performance level is higher or lower than the target performance level, selecting a performance range from amongst the performance ranges included in the selected group, and scheduling transmission to a mobile station included in the selected performance range.

The selection of the performance range may be performed using the scheduling algorithm and the scheduling of transmission to a mobile station included in the selected performance range may be performed using the further scheduling algorithm.

Preferably the method further comprise varying the form of the transmission beam of the base station, and re-determining the at least one transmission threshold and/or each service parameter and/or the performance ranges following variation of the transmission beam. Thus, the method may be able to take account of changing beam conditions.

The base station may be configured to vary the form of the transmission beam in accordance with a random beam-forming technique. It has been found that the amount of multi-user diversity depends on the rate and dynamic range of channel fluctuations. The use of a random beam-forming technique can provide significant performance improvement in slow fading environments by adding fast time-scale fluctuations on the overall channel quality, and may also provide opportunistically null interference between base stations of different cells in the wireless environment or other interference sources.

Known random beam-forming, or other opportunistic beam-forming techniques require large and variable feedback from the mobile stations to the base stations. However, by using a random beam-forming technique as part of the method of the present invention, the amount of feedback required can be reduced, whilst retaining the benefits of the random beam-forming technique.

In a further independent aspect, there is provided a base station comprising means for selecting at least one threshold representative of a performance range, means for transmitting the at least one threshold to a plurality of mobile stations, means for receiving a request for service from at least one mobile station falling within the performance range in response to the transmitted threshold, and means for scheduling transmission to one or more of the mobile stations from which a request for service has been received.

In another independent aspect there is provided a base station comprising means for determining a plurality of performance ranges, means for applying a scheduling algorithm to select one of the performance ranges, means for applying a further scheduling algorithm to select a mobile station included in the selected performance range and to schedule transmission to the selected mobile station.

In another independent aspect there is provided a mobile station comprising means for receiving at least one threshold representative of a performance range, means for determining whether the mobile station falls within the performance range, and means for transmitting a request for service to a base station in dependence whether the mobile stations falls within the performance range.

The means for selecting may comprise a processor or processing module. The means for transmitting may comprise an antenna or antenna array and associated transmission circuitry. The means for receiving may comprise an antenna or antenna array and associated reception circuitry. The means for determining may comprise a processor or processing module. Each of the means for applying a scheduling algorithm and the means for applying a further scheduling algorithm may comprise a processor or processing module.

In a further independent aspect there is provided a communication system comprising: a base station comprising means for selecting at least one threshold representative of a performance range, means for transmitting the at least one threshold to a plurality of mobile stations, means for receiving a request for service from at least one mobile station falling within the performance range in response to the transmitted threshold, and means for scheduling transmission to one or more of the mobile stations from which a request for service has been received; and a plurality of mobile stations, each comprising means for receiving the at least one transmitted threshold, means for comparing the at least one threshold to a service parameter, and means for transmitting a request for service in dependence upon the comparison.

In yet another independent aspect there is provided a communication system comprising, a base station and a plurality of mobile stations, the base station comprising means for determining a plurality of performance ranges, means for applying a scheduling algorithm to select one of the performance ranges, means for applying a further scheduling algorithm select a mobile station included in the selected performance range; and transmission means for transmitting data from the base station to the selected mobile station.

In a further independent aspect there is provided a communication system comprising means for operating in accordance with a method as claimed herein.

In another independent aspect there is provided a computer program product storing computer executable instructions operable to cause a general purpose computer to become configured to perform a method as claimed herein.

In one example, the invention may be used in an on-board aircraft internet system in which passengers may connect their portable computers to the internet via WiFi connection to a on-board server, which can be considered to act as a base station. The channel capacity between the aircraft and the ground equipment may be assigned to one or other of the portable computers using a scheduling method according to the invention.

Mobile terminal controlled multi-user access may be provided, that allows a mobile terminal to become aware of its own status relative to that of other mobile terminals in order to determine if it requires transmission at a specific time slot for network access. The invention may provide initial system level scheduling and further scheduling on user group. Iterative scheduling with a targeted system-level quality of service may be provided.

There may also be provided, in another aspect, a wireless communication system multiuser control mechanism and procedure in order to enable self-controlled mobile users to access network opportunistically, including an initiated network scheduler configured to perform iterative scheduling for selecting a group of mobile stations from a set of automatically grouped mobile stations, in combination with a multi-user scheduling procedure. The iterative scheduling may comprise network iterative scheduling with a range of quality of service including a targeted network quality of service. Self-controlled mobile stations may monitor network performance and service provided, and may estimate their status in the network. Each mobile station may be able to reconfigure itself and/or vary its status and/or to make its own decision concerning the sending of a transmission request. Thus, less signalling may be required and the overall system capacity of a network may be increased. A targeted network performance may be achieved using the opportunistic access of self-controlled MSs. A balancing of a targeted quality of service, a guaranteed quality of service and fairness may be provided.

In another independent aspect there is provided a wireless communication system multiuser control mechanism and procedure to enable self-controlled mobile users to access a network opportunistically with a network scheduler which performs iterative scheduling on top of a multiuser scheduling procedure by automatically grouped mobile stations. In a further independent aspect there is provided a mechanism and methodology of network iterative scheduling in dependence on a certain range of quality of service including a targeted network quality of service, thus providing control over the range of quality of service provided. In a further independent aspect there is provided a self-controlled mobile station that monitors network and service provided, and obtains an estimation of self-status in the network and is capable of reconfiguration to make its own decision on transmission request. There may be provided a mechanism and configuration to perform network scheduling and form broadcasting messages in dependence on one or more of quality of service thresholds, localisation, and transmission format.

Any feature in one aspect of the invention may be applied to other aspects of the invention, in any appropriate combination. In particular, apparatus features may be applied to method features and vice versa.

Embodiments of the invention will now be described, by way of example only, with reference to the accompanying drawings in which:

FIG. 1 is a graph showing a typical distribution of power requirements of users in a cellular environment;

FIG. 2a shows a multi-user system including a base station and mobile stations having different requirements;

FIG. 2b is graph showing an example of data rates and percentages of network access achieved by different mobile stations in the multi-user system of FIG. 2a using conventional proportional scheduling;

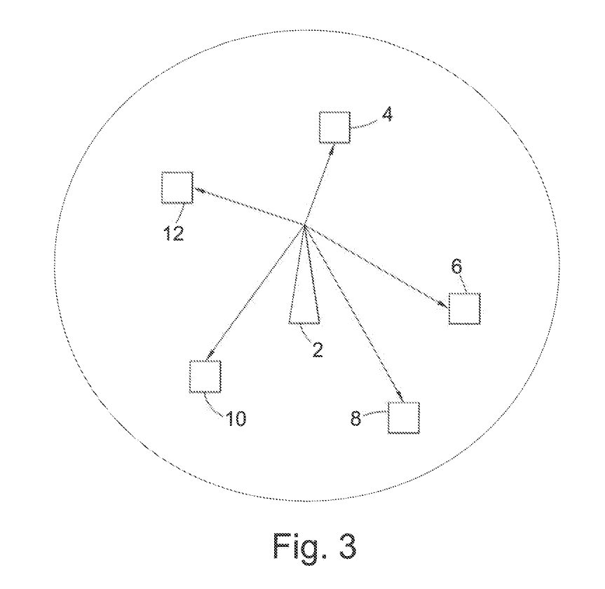

FIG. 3 is a schematic diagram showing an arrangement of a base station and mobile stations in a multi-user network according to the preferred embodiment;

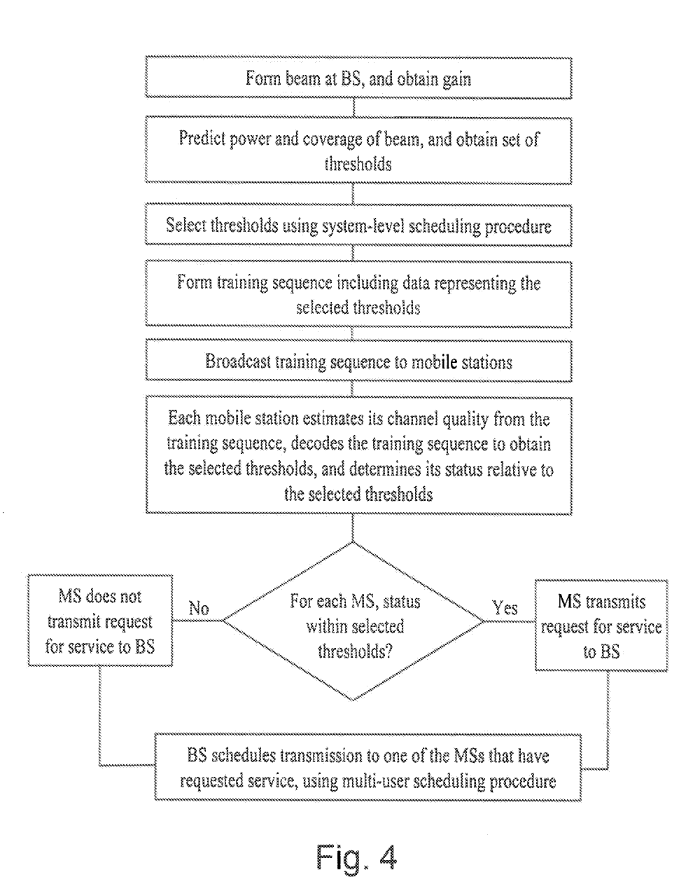

FIG. 4 is a flow chart illustrating operation of the preferred embodiment;

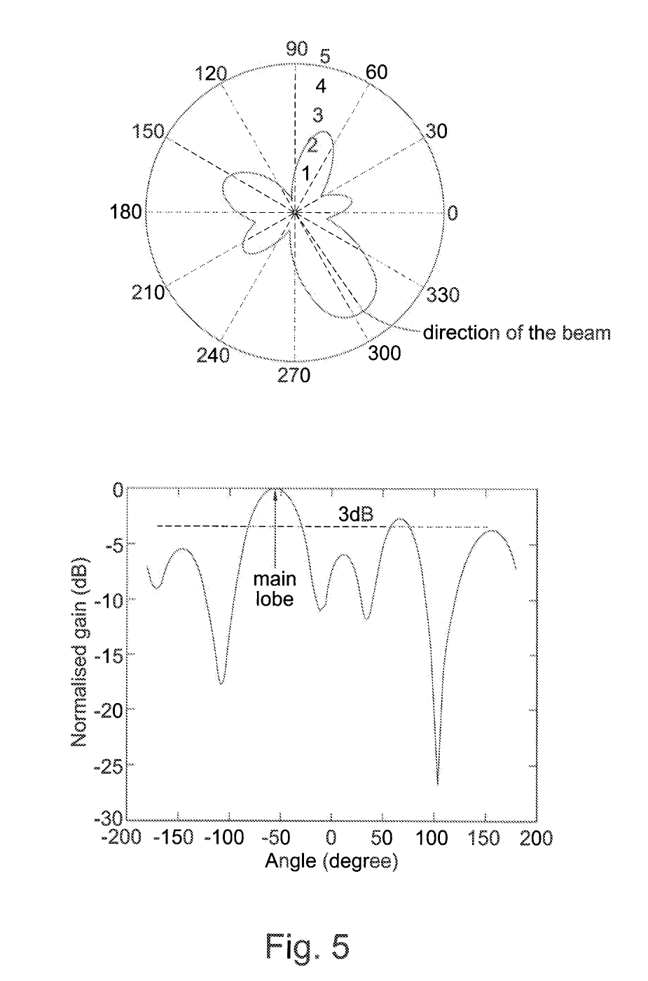

FIG. 5 is an example of a beam pattern formed by random beam-forming;

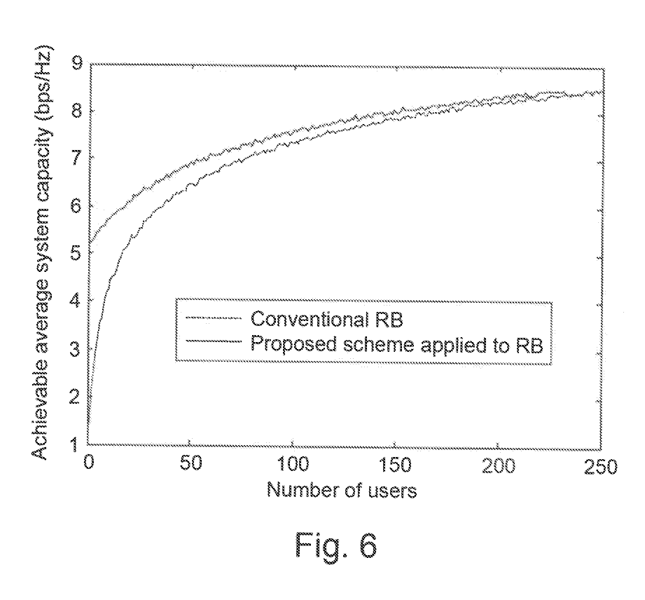

FIG. 6 is a graph showing shows the average system capacity as a function of the number of mobile stations, achieved by the preferred embodiment and by a known, random beam-forming technique;

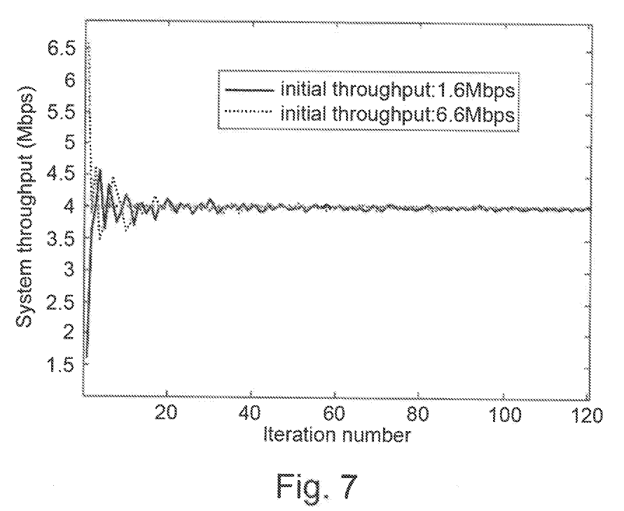

FIG. 7 is a graph showing the variation of data throughput as a function of iteration number according to an example of an iterative scheduling procedure of the preferred embodiment;

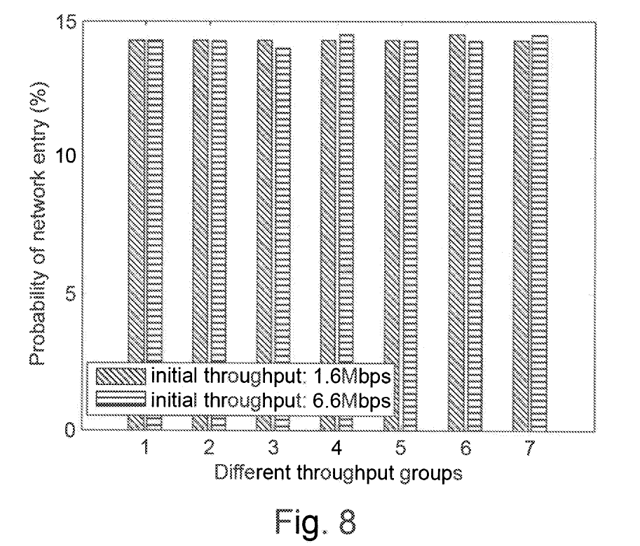

FIG. 8 is a graph showing the probability of network attention for each of the different throughput groups or ranges for the example of FIG. 6;

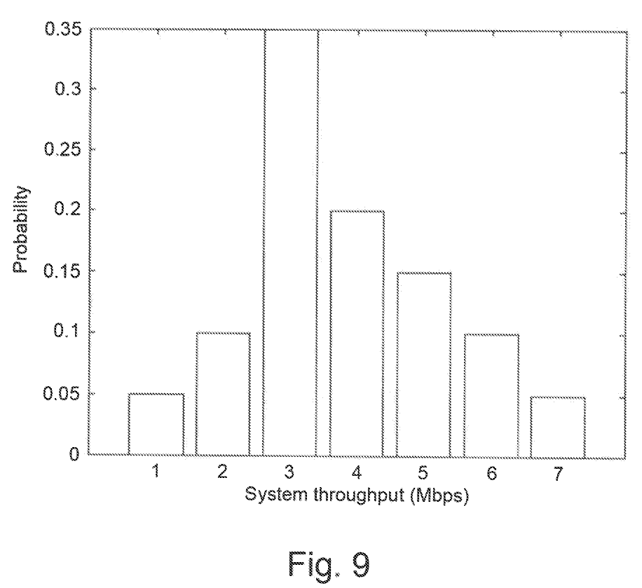

FIG. 9 is a graph showing the weightings given to the different groups or ranges in a modification of the example of FIGS. 6 and 7; and

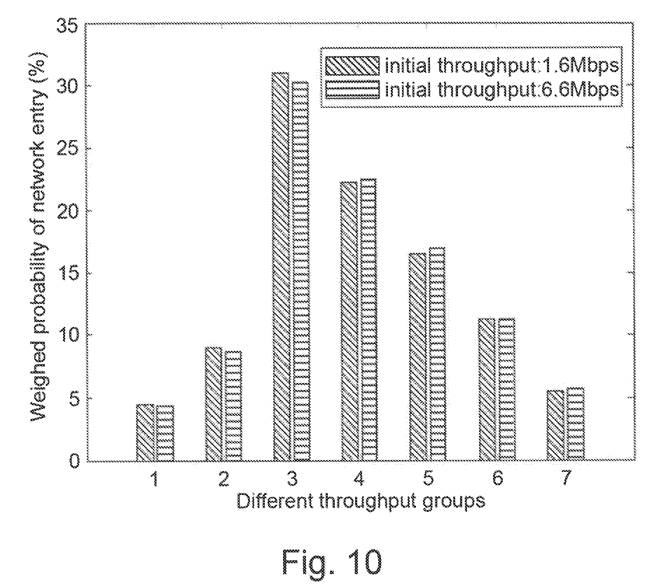

FIG. 10 is a graph showing the probability of network attention for each of the different throughput groups or ranges in the modified example of FIG. 8.

An example of a multi-user system in accordance with the preferred embodiment is shown schematically in FIG. 3. In the example of FIG. 3, the system is a narrow-band downlink wireless communication system in which a base station 2 communicates with K users in the form of mobile stations, each having a single receiver. Five of the K mobile stations 4 6 8 10 12 are shown in FIG. 3, for the purposes of illustration.

The K mobile stations are of a variety of different types, and have different quality of service requirements. The K mobile stations include, for instance, mobile telephones, laptops, and embedded devices and may require communication with the base station for a variety of different applications, including streaming video or audio, e-mail, location applications, or communication with a control device. The channels between the base station and the K mobile stations also have different channel quality, which may vary over time depending on a variety of factors including variation of characteristics of the transmission beam, distance of each mobile station from the base station, and interference effects.

The base station 2 includes an antenna array and a control processor. The control processor is configured to be able to control the form of the beam emitted by the antenna array, to receive and process data from the mobile stations and to schedule transmission to a selected one or more of the mobile stations at any given time.

Each mobile station includes a respective antenna or antenna array and associated receiver circuitry, and a processor configured to process signals received by the antenna or antenna array and associated receiver circuitry.

The baseband time-slotted block-fading channel model gives, for the k^{th} user:

yₖ(t)=hₖ(t)x(t)+nₖ(t), k=1,2, . . . , K. (1)

where x(t) is the vector of transmitted symbols in time slot t, yₖ(t) is the vector of received symbols of user k at time slot t, hₖ(t) is the fading channel gain from the transmitted and receiver k in time slot t, and nₖ(t) is Gaussian random noise vector.

Assuming that E└∥x(t)∥²┘=P_{Tx}, where P_{Tx} is the transmit power level then the corresponding signal-to-noise ratio (SNR) can be expressed by

$$S N R = \frac{{P}_{Tx} \cdot {P}_{{h}_{k} ( t )}}{{P}_{{n}_{k} ( t )}} . \qquad ( 2 )$$

If power control is not required in the system then P_{Tx} is fixed and for a practical system, the noise power level can be assumed to be constant as well. In that case, the SNR has a linear relation with the channel power (Pₕ_{ₖ}₍ₜ₎) and is referred to as the channel SNR.

The control processor of the base station 2 is operable to implement a variety of different scheduling techniques, based on a variety of different parameters, examples of which are discussed in more detail below. However, a feature of the system is that, regardless of the particular scheduling technique, the mobile stations are able to perform a self-selection based on data sent from the base station. For instance, each mobile terminal can be configured to compare a transmission threshold received from the base station to a service parameter, for instance a measure of channel quality, signal to noise ration, desired quality of service, or desired data transmission for that mobile station, with the scheduling of transmission being dependent on the outcome of the comparisons.

Each mobile station is also able to track its own channel SNR (this can be done via a common downlink pilot signal for instance) and is able to feed back the instantaneous channel or link quality to the base station if required. Depending on the scheduling technique chosen, the base station may be configured to schedule transmissions among the mobile stations that have requested transmission, and to adapt the rate of data transmission, as a function of the instantaneous channel quality. That feature can enhance the multi-user diversity effect in a system with many users with independently varying channels. At any time it is likely that there is a user with channel much stronger than the average SNR, and the base station may be configured to transmit to users with strong channels at all times, in order to increase the overall spectral efficiency of the system.

In one mode of operation, the control processor of the base station 2 sets up a range of performance, for instance quality of service (QoS), with upper and lower threshold values for pre-assigning possible user access. These two threshold values are applied as a guideline and are broadcast by the base station 2, for instance through an advertisement message or messages.

All mobile stations within the cell coverage of the base station are required to listen to the base station and decode the message. The decoded message contains the threshold values, which are then processed by the mobile terminals.

Meanwhile, each mobile station estimates the channel or link quality between base station and mobile station, using any one of the known techniques which can be used to determine the received power at a mobile station.

Based on the threshold values and the estimated link quality, each mobile station determines its mode of transmission request, and transmits the result of that determination to the base station.

If a mobile station is not requesting transmission as its quality of service is out of the quality of service range, the mobile station does not transmit any feedback message to the base station, also referred to as sending a null feedback. Alternatively, it feeds back an indication (which can be a message with one bit or small number of bits) which indicates ‘no transmission request’. The indication may be in the form of a NACK message.

If a mobile station wishes to request transmission as its quality of service is within the quality of service range, then it sends a request for service message to the base station.

Thus, the base station is notified of those mobile stations that are requesting transmission, enabling opportunistic scheduling to be implemented. In this case, all of the mobile stations requesting transmission from the base station are within the scope of the quality of service set by the base station.

A multi-user transmission technique is then used to schedule transmission to one or more of the mobile stations that have requested transmission from the base station. The multi-user transmission technique may be, for example, one of a random beam-forming, cooperative transmission or opportunistic relay technique.

It should be noted that the base station can have one threshold level or several threshold levels.

In the preferred mode of operation, a double scheduling is used, in which the threshold levels are selected using a scheduling technique, and in which one of the mobile stations that subsequently request transmission from the base station (based on the selected threshold levels) is selected using a further scheduling technique.

The preferred mode of operation is illustrated schematically in the flow chart of FIG. 4. The processes carried out in an example of the preferred mode of operation, in which system performance is used to fix the threshold levels, in which a random beam-forming technique is used, and which provides mobile station-controlled opportunistic access, are now considered in more detail, and listed under points a) to n):

a) The base station performs a random beam-forming operation using the antenna array. An example of a beam pattern resulting from a random beam forming operation is shown in FIG. 5. In variants of the preferred embodiment the beam-forming operation is an omni or sector beam-forming.

b) Based on the formed beam, the base station calculates the effective antenna gain (dBi).

c) With the effective antenna gain and transmit power, the base station predicts its transmitted power and coverage range.

d) Based on the predicted transmit power, coverage and scheduling, a set of thresholds is set up which define a plurality of performance ranges. The performance ranges may be based upon quality of service.

e) A system-level scheduling is performed according to system performance in order to select one of the performance ranges.

f) Optimal directional indication is also estimated at the base station, based on efficient power to distance ratio, to give clearer coverage.

g) A training sequence is formed, including the thresholds representing the selected performance range, for the purpose of allowing each mobile stations to receive and decode the thresholds, and to allow each mobile station to obtain all other necessary parameters, including its own status with respect to the thresholds based for instance on distance to base station and quality of service.

h) The training sequence is broadcast into the network.

i) All mobile stations within the coverage of the base station listen to the base station and decode the information relating to the network, including the set of thresholds.

j) Each mobile station determines its respective status in the network and determines its corresponding feedback status by comparing its status with the thresholds. Each mobile station's status is determined not only by the quality of the link or channel to the base station (based on, for example, direction of arrival of transmissions from the base station, location in the cell, mobile channel quality), but also on required service and quality of service. Known mobile station localisation techniques can be used in the determination, for each mobile station, of the quality of the link or channel to the base station.

k) Each mobile station that falls within the thresholds feeds back to the base station a measurement of its status and with a request to receive data from the base station.

l) Those mobile stations that are outside the range of thresholds do not feed back any information to the base station. In a variant of the preferred embodiment, the mobile stations that are outside the range of thresholds feed back a NACK message to the base station.

m) With the information received from the mobile stations, the base station performs a multi-user scheduling procedure to select one of the mobile stations.

n) The base station transmits the data requested by the selected mobile station to that mobile station.

The procedures described under e) to n) are repeated. The procedures under a) to d) may also be repeated occasionally, for instance in dependence upon channel variations, or periodically, for instance for each data frame, to provide altered beam characteristics and thresholds.

FIG. 6 shows the achieved average system capacity (in bps/Hz) as a function of the number of mobile stations for one example of the preferred mode of operation, in which a greedy scheduling algorithm for maximising total throughput is applied as the multi-user scheduling procedure of m). It can be seen that the preferred mode of operation provides much higher performance than conventional random beam-forming technique, particularly for small numbers of mobile stations, due to the fact that only mobile stations within the range selected by the base station request transmission at any one time.

System-Level Proportional Scheduling

The system-level scheduling performed according to system performance mentioned under e) is a significant feature of the preferred embodiment, and is now considered in more detail.

The system-level scheduling is dependent on the system throughput or performance, and is based on modifications of known scheduling algorithms. In the preferred embodiment, the system-level scheduling is a modified form of a proportional scheduling technique.

A known proportional scheduling algorithm works as follows. The algorithm keeps track of the average throughput Tₖ(t)of each user, k, in a past window of length t_{c}. In time slot t, the scheduling algorithm simply transmits to the user k* with the largest ratio of a requested data rate Rₖ(t) to Tₖ(t) as Rₖ(t)/Tₖ(t) among all active users in the system.

Then, the average throughputs Tₖ(t) can be updated using an exponentially weighted low-pass filter:

$${T}_{k} ( t ) = \{ \begin{matrix}( 1 - \frac{1}{{t}_{c}} ) {T}_{k} ( t ) + \frac{1}{{t}_{c}} {R}_{k} ( t ) , & k = {k}^{*} \\ ( 1 - \frac{1}{{t}_{c}} ) {T}_{k} ( t ) , & k \neq {k}^{*}\end{matrix} . \qquad ( 3 )$$

According to a proportional scheduling algorithm, users compete for resources not directly based on their requested rates but only after normalization by their respective average throughputs. The user with the statistically stronger channel will have a higher average throughput. Thus, the algorithm schedules a user when its instantaneous channel quality is high relative to its own average channel condition over the time scale.

In the preferred embodiment, a system level proportional scheduling, based on system performance is used. As mentioned above under d), the base station sets up a plurality of performance ranges, each of which may include many mobile stations. In the system level scheduling procedure, which is based on the proportional scheduling algorithm described above, the requested data rate is not determined purely for a single user but instead is determined for a group of users or mobile stations. The average throughputs are also determined for groups of users or mobile stations.

The system level scheduling procedure mentioned under e) of the preferred mode of operation, comprises the following:
The desired data rate for each performance range determined under d) above is calculated, and represented by Rₙ^{R}(t), where n=1,2, . . . ,N, N is the total number of the performance ranges.
In an initial scheduling and transmission procedure, initial transmissions from the base station to mobile stations are carried out according to a known scheduling algorithm, for example a first-come first-served (FCFS) algorithm, or a greedy algorithm or a proportional algorithm.
After each transmission to a mobile station, the base station collects the average throughput of the range to which the mobile station belongs, represented by Tₙ^{R}(t).
After a pre-determined period of network operation, the initial scheduling and transmission procedure is ended, with a value of Rₙ^{R}(t) and Tₙ^{R}(t) for each of performance ranges n=1, 2, . . . , N having been established.
The base station then applies the system level scheduling algorithm, which comprises selecting that one of the performance ranges, n, having the largest ratio of requested data rate Rₙ^{R}(t) to Tₙ^{R}(t) as Rₙ^{R}(t)/Tₙ^{R}(t) among all active performance ranges.

The base station then broadcasts the thresholds representing the selected performance range, as part of a training sequence as mentioned under g) and h) above. Those mobile stations that are within the selected performance range, as defined by the thresholds, feed back to the base stations in accordance with i) to l) above. A further multi-user scheduling procedure is then performed to select one of the mobile stations that lie within the selected range, in accordance with m) above. The base station then transmits data requested by the selected mobile station to that mobile station, in accordance with n) above.

The base station updates the values of Rₙ^{R}(t) and Tₙ^{R}(t) in light of the transmission to the selected mobile station and then, to start the next iteration, applies the system level scheduling algorithm again to select one of the performance ranges using the updated values of Rₙ^{R}(t) and Tₙ^{R}(t).

Thus, the preferred mode of operation includes a double scheduling procedure in which a system-level scheduling procedure is used to select a performance range, and in which a further scheduling procedure is used to select a mobile station falling within that performance range.

The use of the initial scheduling and transmission procedure until values of Rₙ^{R}(t) and Tₙ^{R}(t) are established means that there is no delay in beginning transmission compared to known transmission scheduling procedures.

In a variant of the system of the preferred embodiment, in order to further reduce MAC overhead, threshold separation value, also referred to as a default scalar of range indication, is provided representing the separation between the thresholds for each pair of thresholds. The default scalar of the range indication is recognised by each mobile station upon initial entry to the network. The base station then needs to broadcast only one threshold value to the mobile stations in the network that it serves. The mobile stations are then able to calculate all other threshold values based on the received threshold value and the default scalar of range indication.

Iterative Scheduling

In another variant of the preferred embodiment, the system level scheduling of e) is modified and further comprises an iterative scheduling, based on a targeted quality of service or network performance level. The targeted quality of service or network performance level may be the choice of a network operator, and may be related, for example, to characteristics of the network or service provided or, in some circumstances, to a business model profit target.

The iterative scheduling according to the variant of the preferred embodiment comprises the following:
i) Based on the performance ranges set up under d), a targeted network performance level is determined.
ii) Two performance groups are set up:
   a high-performance group, which comprises those performance ranges that are greater than the targeted network performance level
   a low-performance group, which comprises those performance ranges that are lower than the targeted network performance level.
iii) At the beginning of system operation, the base station randomly selects a range from the set of performance ranges as its starting point.
iv) The selected range is taken as representing the average system performance at the starting point.
v) If the average system performance is greater than the target network performance, the base station selects one of the performance ranges from the low-performance group. The performance range may be selected from amongst the performance ranges of the low-performance group using the system level scheduling procedure of the preceding section. In one example, the performance range that is selected by the base station is that performance range from the low performance group having the lowest network access percentage. If there are several performance range having equal percentage ranges, the system randomly selects one.
vi) If the average system performance is lower than the targeted network performance, the base station selects one of the performance ranges from the high-performance group. The performance range may be selected from amongst the performance ranges of the high-performance group using the system level scheduling procedure of the preceding section. In one example, the performance range that is selected by the base station is that performance range from the high performance group having the lowest network access percentage. If there are several performance range having equal percentage ranges, the system randomly selects one.
vii) The base station selects one of the mobile stations from the selected performance range, for instance using the multi-user scheduling procedure of step m).
viii) The base station updates the percentage of network access of the performance ranges, and the average system performance. The percentage of network access can be weighted according to network budget if required.
ix) The processes from v) to viii) are repeated.

The iterative scheduling procedure is able to achieve a quick convergence to a targeted quality of service and at the same time achieves fairness of scheduling to mobile stations falling within different quality of service or throughput groups or ranges, as is illustrated with reference to FIGS. 7 to 10.

FIG. 7 shows the throughputs achieved as a function of iteration number for an example of the iterative scheduling procedure, using seven different throughput groups or ranges, based on a targeted throughput of the system. It shows a quick convergence from an initial throughput of 1.6 Mbps in one case, and 6.6 Mbps in another case, to a targeted throughput of 4 Mbps. FIG. 8 shows the probability of network attention for each of the different throughput groups or ranges of the example of FIG. 7. It can be seen from FIGS. 7 and 8 that, as well as a fast convergence to the targeted throughput, all of the different groups have fair access to the network and service.

It is straightforward to provide different weightings to different groups or ranges, if desired, so that different groups or ranges receive different levels of attention in a desired proportion. FIG. 9 shows graphically the weightings given, using a weighting vector, to the seven groups or ranges in a modification of the example of FIGS. 7 and 8. FIG. 10 shows the probability of network attention achieved using the iterative scheduling procedure by each of the seven groups or ranges, for an initial throughput of both 1.6 Mbps and 6.6 Mbps. It can be seen from FIG. 10 that the achieved relative levels of attention provided to the different groups or ranges match well the weightings illustrated in FIG. 9.

Antenna Gain

In the preferred embodiment, the set of thresholds that are used are based upon transmit power, coverage and scheduling, as described under c) and d) of the preferred mode of operation. The control of transmit power based upon antenna gain calculations is now considered further, particularly in relation to the random beam-forming operation of the preferred embodiment.

Antenna gain (dBi) is commonly used in communication to express either a gain or loss in power between an input and output device and is expressed as a ratio of the signal power increase over a half-wave dipole dB or over an isotropic source dBi.

There are several ways to calculate the antenna gain as described in C. A. Balanis, Antenna Theory—Analysis and Design, John Wiley & Sons, Inc. 1982 and H. L. V. Trees, Optimum Array Processing, Wiley Interscience, 2002.

The antenna gain is determined by the intended area of coverage. The gain at a given wavelength is achieved by appropriately choosing the size of the antenna. The gain may also be expressed in terms of the half power beam width. It is important to determine the antenna gain appropriately.

The random beam-forming process forms a random beam at the base station. The random beam-forming process provides for random changes in the beam over time. As the beam changes, the effective transmit power and hence cell coverage is changed. The gain of the antenna is closely related to the directivity which is a measure that takes into account the efficiency of the antenna and its directional capability, thereby describing the directional properties of the antenna, which are determined by the antenna pattern.

Absolute gain of an antenna (in a given direction) is defined as the ratio of the intensity in a given direction to the radiation intensity that would be obtained if the power received/transmitted by the antenna radiated isotropically. The radiation intensity corresponding to the isotropically radiated power is equal to the power accepted by the antenna divided by 4π and can be expressed mathematically as

$$G = 4 π \frac{U ( θ , φ )}{{P}_{in}} ( dimensionless ) \qquad ( 4 )$$

where U(θ, φ) represents the radiation intensity, and P represents the input power.

When the direction is not stated, the power gain takes into account the direction of maximum radiation. With a definition of the antenna radiation efficiency, e_{cd}, the total radiated power (P_{rad}) is related to the total input power (Pᵢₙ) by,

P_{rad}=e_{cd}Pᵢₙ (5)

It should be noted that the efficiency included the losses arising from impedance mismatches (reflection losses) and polarization mismatches (losses). Any polarization mismatches are usually controlled by the base station. Therefore, Equation 4 can be rewritten as

$$G = {e}_{cd} [ 4 π \frac{U ( θ , φ )}{{P}_{rad}} ] \qquad ( 6 )$$

A typical beam pattern produced by the random beam-forming is depicted in FIG. 5, as an example. The antenna gain of the beam can be obtained as described above.

The beam pattern and the gain are used by the base station to predict the probability of the system performance and the distribution of the quality of service, based upon previous performance and distribution of quality of service obtained over a period of time, for instance over a week or a few weeks.

In one mode of operation a different random beam pattern is produced periodically during transmission, for instance on each frame, and in that case the antenna gain is measured or calculated for each produced beam pattern. Based on the gain of the antenna, the radiated power from the random beam can be estimated or measured and then controlled.

There are two different cases for the power control consideration. The first one is as defined in conventional random beam-forming where no specific power control is applied. In that case, the coverage varies according to the gain of the beam produced by the random beam-forming. Therefore, it is possible to predict the variation of received power at mobile stations from the gain of the beam in order to set up reasonable thresholds.

However, in many practical applications/systems, transmission is carried out according to Effective Isotropic Radiated Power (EIRP) which is the apparent power transmitted towards a receiver, if it is assumed that the signal is radiated equally in all directions, i.e. as a spherical wave emanating from a point source. The EIRP limitation is mainly on base station for cellular operation. Therefore, this corresponding power is given by

EIRP=Gₜ·Pₜ (7)

where Gₜ is the gain of random beam and Pₜ is the power transmitted. Then the transmit power for random beam-forming should be controlled by

$${P}_{t} = \frac{E I R P}{{G}_{t}} \qquad ( 8 )$$

Consequently, the coverage range is changed according to the beam pattern and the transmit power. This also easily supports the set up of the threshold values at the base station and is recognised by all mobile stations that it serves.

It will be understood that the present invention has been described above purely by way of example, and modifications of detail can be made within the scope of the invention.

Each feature disclosed in the description, and (where appropriate) the claims and drawings may be provided independently or in any appropriate combination.

1. A method of scheduling transmission between a base station and a plurality of mobile stations, comprising:
determining at least one transmission threshold;
transmitting the at least one transmission threshold to the plurality of mobile stations;
comparing, at each mobile station, the at least one transmission threshold to a service parameter for that mobile station; and
scheduling transmission from the base station, the scheduling being dependent on the outcome of the comparisons.

2. A method according to claim 1, wherein each mobile station determines whether or not to send a request for service to the base station in dependence upon the comparison at that mobile station.

3. A method according to claim 1, wherein the or each transmission threshold comprises a quality of service threshold

4. A method according to claim 1, wherein each mobile station determines the value of its own service parameter.

5. A method according to claim 1, further comprising determining a plurality of transmission thresholds, the plurality of transmission thresholds defining a set of performance ranges.

6. A method according to claim 5, further comprising selecting at the base station at least one of the performance ranges, the at least one transmission threshold transmitted to the plurality of mobile stations being representative of the selected at least one performance range.

7. A method according to claim 6, wherein the selection of one of the performance ranges of the plurality of performance ranges is performed using a scheduling algorithm.

8. A method according to claim 7, further comprising selecting one of the mobile stations falling within the selected performance range using a further scheduling algorithm.

9. A method according to claim 1, further comprising:
a) determining a target performance level,
b) determining an achieved performance level,
c) comparing the target performance level and the achieved performance level,
d) scheduling transmission in dependence upon the comparison,
e) updating the achieved network performance level following the scheduled transmission, and
f) repeating b) to e)

10. A method of scheduling transmission from a base station to a plurality of mobile stations, comprising:
determining a plurality of performance ranges;
applying a scheduling algorithm to select one of the performance ranges;
applying a further scheduling algorithm to select a mobile station included in the selected performance range; and
scheduling transmission from the base station to the selected mobile station.

11. A method according to claim 10, wherein each of the performance ranges is a respective range of quality of service.

12. A method according to claim 5, further comprising:
g) determining a target performance level,
h) determining an achieved performance level,
i) comparing the target performance level and the achieved performance level,
j) scheduling transmission in dependence upon the comparison,
k) updating the achieved network performance level following the scheduled transmission, and
l) repeating b) to e)

13. A method according to claim 12, further comprising assigning each performance range to either a high performance group or a low performance group, and selecting one of the high performance group or the low performance group in dependence on whether the achieved performance level is higher or lower than the target performance level, selecting a performance range from amongst the performance ranges included in the selected group, and scheduling transmission to a mobile station included in the selected performance range.

14. A method according to claim 13, wherein the selection of the performance range is performed using a scheduling algorithm comprising selecting at the base station at least one of the performance ranges, the at least one transmission threshold transmitted to the plurality of mobile stations being representative of the selected at least one performance range and the scheduling of transmission to a mobile station included in the selected performance range is performed using a further scheduling algorithm.

15. A base station comprising means for selecting at least one threshold representative of a performance range, means for transmitting the at least one threshold to a plurality of mobile stations, means for receiving a request for service from at least one mobile station falling within the performance range in response to the transmitted threshold, and means for scheduling transmission to one or more of the mobile stations from which a request for service has been received.

16. A base station comprising means for determining a plurality of performance ranges, means for applying a scheduling algorithm to select one of the performance ranges, means for applying a further scheduling algorithm to select a mobile station included in the selected performance range and to schedule transmission to the selected mobile station.

17. A mobile station comprising means for receiving at least one threshold representative of a performance range, means for determining whether the mobile station falls within the performance range, and means for transmitting a request for service to a base station in dependence whether the mobile stations falls within the performance range.

18. A communication system comprising:
a base station comprising means for selecting at least one threshold representative of a performance range, means for transmitting the at least one threshold to a plurality of mobile stations, means for receiving a request for service from at least one mobile station falling within the performance range in response to the transmitted threshold, and means for scheduling transmission to one or more of the mobile stations from which a request service has been received; and
a plurality of mobile stations, each comprising means for receiving the at least one transmitted threshold, means for comparing the at least one threshold to a service parameter, and means for transmitting a request for service in dependence upon the comparison.

19. A communication system comprising, a base station and a plurality of mobile stations, the base station comprising means for determining a plurality of performance ranges, means for applying a scheduling algorithm to select one of the performance ranges, means for applying a further scheduling algorithm to select a mobile station included in the selected performance range; and transmission means for transmitting data from the base station to the selected mobile station.

20. A communication system comprising means for operating in accordance with claim 1.

21. A computer program product storing computer executable instructions operable to cause a general purpose computer to become configured to perform a method in accordance with claim 1.
